(19) United States
(12) Patent Application Publication
(10) Pub. No.: US 2011/0164022 A1
(43) Pub. Date: Jul. 7, 2011

(54) Common Voltage Driving Circuit for High-Resolution TFT-LCD

(75) Inventors: Hsien-Ting Huang, Sinshih Township (TW); Yaw-Guang Chang, Sinshih Township (TW)

(73) Assignee: HIMAX TECHNOLOGIES LIMITED, Sinshih Township (TW)

(21) Appl. No.: 12/652,145

(22) Filed: Jan. 5, 2010

(51) Int. Cl. G06F 3/038

(52) U.S. Cl. 345/212; 345/92

(57) ABSTRACT

A common voltage driving circuit configured to output a common voltage to high-resolution TFT-LCD is provided. The common voltage driving circuit includes: a first pad coupled to a common electrode loading of an LCD for sensing a common voltage of the common electrode loading; a second pad coupled to the common electrode loading; a first amplifying device receiving a high level voltage and the sensed common voltage of the common electrode loading for generating a first overdrive voltage to the second pad thereby improving transient response of the common voltage with high level; and a second amplifying device receiving a low voltage level voltage and the sensed common voltage of the common electrode loading for generating a second overdrive voltage to the second pad thereby improving transient response of the common voltage with low level.

### FIELD OF THE INVENTION

The present invention relates to a common voltage driving circuit for high-resolution TFT-LCD.

### DESCRIPTION OF THE RELATED ART

Large-sized LCDs are currently one type of commonly used and fabricated display device. As the size an LCD increases, the resolution of the LCD becomes higher. Additionally, as the size the LCD increases, the driving time thereof must decrease to maintain high resolution states. A conventional common voltage (VCOM) driving circuit 100 for a TFT-LCD is shown in FIG. 1A. The common voltage driving circuit 100 is used to drive a VCOM loading 140 (i.e. a panel of the TFT-LCD). The common voltage driving circuit 100 includes a first operational amplifier 110 and a second operational amplifier 120, a first switch 115, a second switch 125 and a pad 130 with an ITO resistor 132. The voltage quality at the common electrode of the TFT-LCD (VCOM_G) determines whether the VCOM loading is operating smoothly and stably. The voltage quality at the VCOM_G is determined by the quality of the common voltage driving circuit 100. The voltage waveform of the common voltage driving circuit 100 is as shown in FIG. 1B. As shown, the waveform at node VCOM_P on the pad 130 which is an output terminal of the driving circuit 100 illustrates good voltage response. However, after the voltage response at node VCOM_P passes through pad 130 with a pad resistor 132, the waveform at the VCOM_G is delayed or decays. That's because the first operational amplifier 110 and the second operational amplifier 120 are connected as a buffer such that heir output terminal VCOMH and VCOML are pulled down by their inverting input terminals. Thus, the driving capacities of the first operational amplifier 110 and the second operational amplifier 120 are lowered. Moreover, the voltage quality of the VCOM loading is not stably maintained, hindering display quality of the TFT-LCD.

Thus, a driving circuit to raise driving ability of the common voltage of a TFT-LCD is called for.

### BRIEF SUMMARY OF INVENTION

A detailed description is given in the following embodiments with reference to the accompanying drawings.

The present invention provides a common voltage driving circuit for high-resolution TFT-LCD. The common voltage driving circuit includes: a first pad coupled to a common electrode loading of an LCD for sensing a common voltage of the common electrode loading; a second pad coupled to the common electrode loading; a first amplifying device receiving a high level voltage and the sensed common voltage of the common electrode loading for generating a first overdrive voltage to the second pad thereby improving transient response of the common voltage with high level; and a second amplifying device receiving a low voltage level voltage and the sensed common voltage of the common electrode loading for generating a second overdrive voltage to the second pad thereby improving transient response of the common voltage with low level.

The above-mentioned common voltage driving circuit for high-resolution TFT-LCD is designed to overdrive output voltage of the driving circuit to improve common voltage driving speed at the common electrode of the TFT-LCD, such that high resolution state of the TFT-LCD is efficiently maintained.

### BRIEF DESCRIPTION OF DRAWINGS

The present invention can be more fully understood by reading the subsequent detailed description and examples with references made to the accompanying drawings, wherein:

FIG. 1A is a schematic diagram showing a conventional common voltage driving circuit for a TFT-LCD;

FIG. 1B shows voltage waveforms of the conventional common voltage driving circuit for a TFT-LCD;

FIG. 2A is a schematic diagram showing the common voltage driving circuit for a TFT-LCD according to an embodiment of the present invention; and

FIG. 2B shows voltage waveforms of the common voltage driving circuit for a TFT-LCD according to an embodiment of the present invention.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

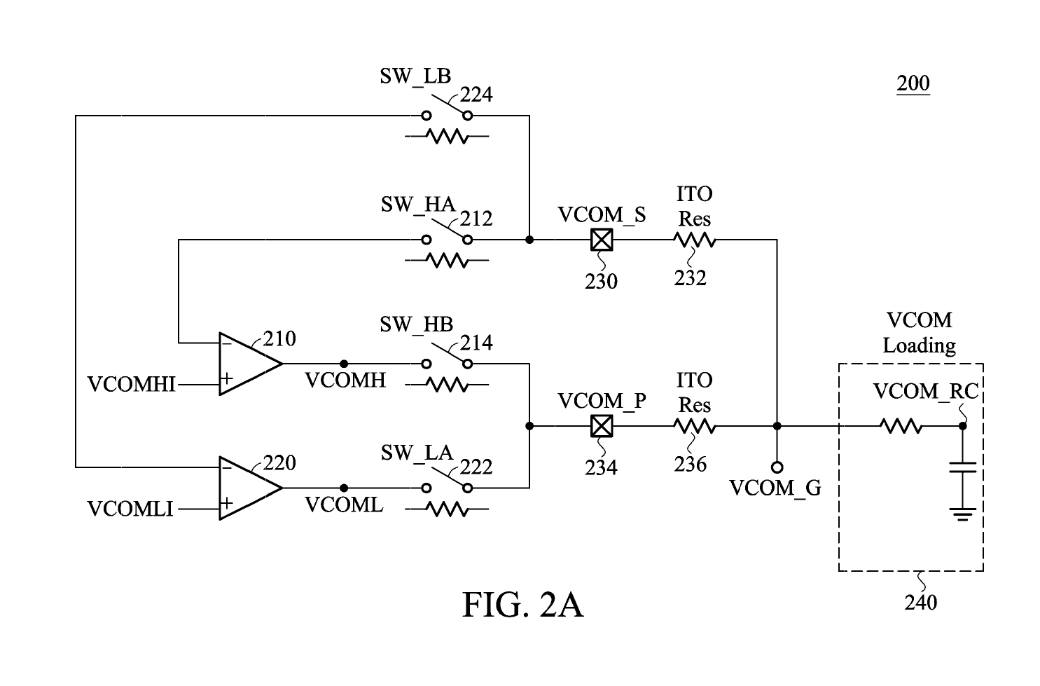

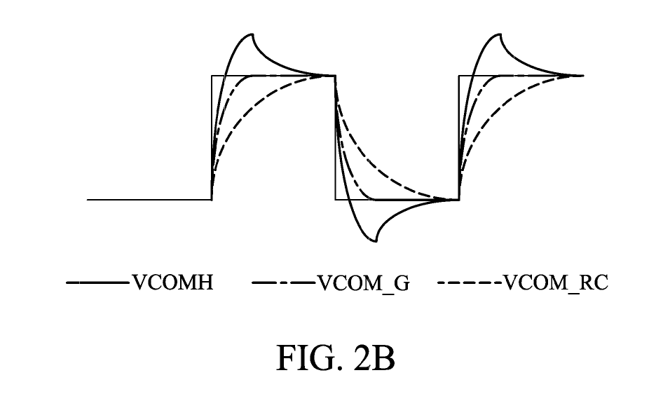

FIG. 2A is a schematic diagram showing the common voltage driving circuit 200 for a TFT-LCD according to an embodiment of the present invention. The common voltage driving circuit 200 may be implemented inside a driver IC such as chip, microprocessor etc, which is connected to a common electrode loading (VCOM loading i.e. a display panel) of an LCD. The common voltage driving circuit 200 comprises a first pad 230 with an ITO resistor 232, a second pad 234 with an ITO resistor 236, a first amplifying device such as a first operational amplifier 210, a second amplifying device such as a second operational amplifier 220, two first switches including SW_HA 212 and SW_HB 214, and two second switches including SW_LA 222 and SW_LB 224.

The first pad 230 and the second pad 234 are coupled respectively to the VCOM loading 240. The first pad 230 is also connected to the inverting input terminal of the first amplifier 210 through SW_HA 212 of the two first switches. Thus, a common voltage VCOM_G on the common electrode loading (VCOM loading) 240 may feedback to the first operational amplifier 210. The first pad 230 is further connected to the inverting input terminal of the second amplifier 220 through SW_LB 224 of the two second switches. Thus, the common voltage VCOM_G on the common electrode loading (VCOM loading) 240 may also feedback to the second operational amplifier 220.

The second pad 234 is connected to the output terminal of the first operational amplifier 210 through the other first switch SW_HB 214. The second pad 234 is also connected to the output terminal of the second operational amplifier 220 through the other second switch SW_LA 222. The non-inverting input terminal of the first operational amplifier 210 is connected to a reference voltage such as a high level voltage (VCOMHI). The non-inverting input terminal of the second operational amplifier 220 is connected to another reference voltage such as a low voltage level voltage (VCOMLI).

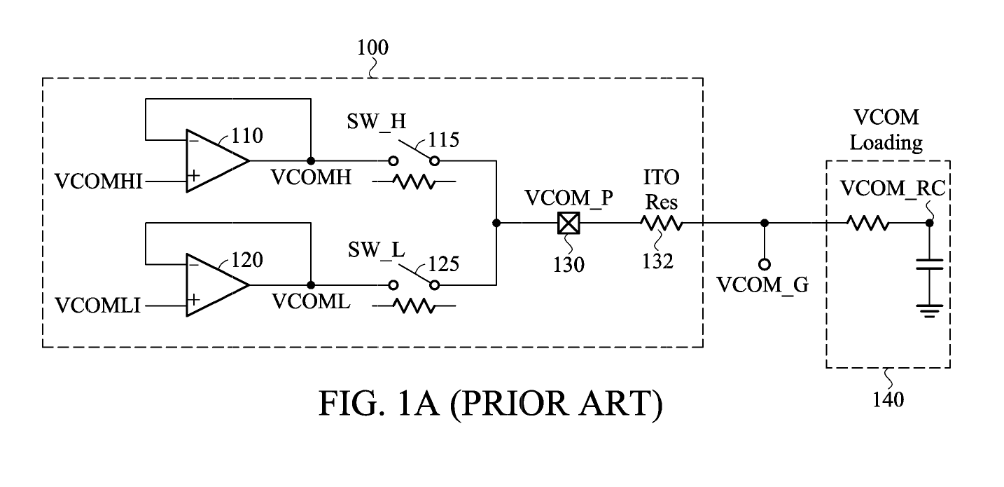

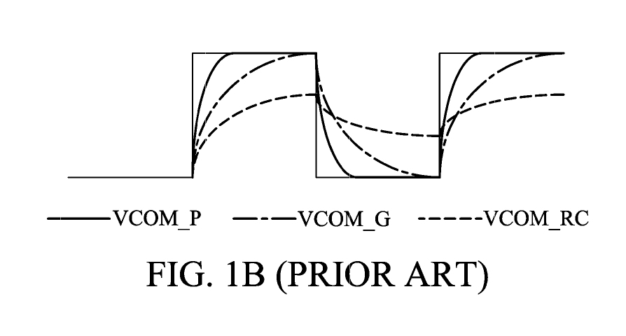

In this manner, the first pad 230 can sense the common voltage VCOM_G on the common electrode loading, and then passes the sensed common voltage to the inverting input terminal of the first operational amplifier 210 and the second operational amplifier 220 respectively. The first operational amplifier 210 and the second operational amplifier 220 both are not connected as buffers as the operational amplifiers showed in FIG. 1A such that their output terminals will not be pulled down by their inverting input terminals. Thus, the driving capacities of the first operational amplifier 210 and the second operational amplifier 220 increases.

During a driving period, the first operational amplifier 210 receives a high level reference voltage (VCOMHI) and the sensed common voltage from the first pad 230 to generate an output current to flow into the second pad 234 to produce a first overdrive voltage. The first overdrive voltage may be overdriven to a high voltage level such as 5V or 3V on the second pad 234. The voltage waveforms in the driving circuit 200 are as shown in FIG. 2B. For example, when the first operational amplifier 210 is operative, the two first switches 212 and 214 are switched on and the two second switches 222 and 224 are switched off, the voltage VCOM_P on the second pad 234 of the driving circuit 200 is overdriven to a high voltage level when compared to that on the pad 130 of the conventional driving circuit 100. In this manner, the common voltage VCOM_G on the common electrode reaches a targeted high voltage level faster than conventional methods. Additionally, at the same time, the common voltage VCOM_G is fed back to the inverting input terminal of the first operational amplifier 210. Thus, improving the high voltage level response of the common voltage VCOM_G.

During another driving period, the second operational amplifier 220 receives a low voltage level reference voltage (VCOMLI) and the sensed common voltage from the first pad 230 to generate a negative current to flow into the second pad 234 to produce a second overdrive voltage. The second overdrive voltage may be overdriven to a low voltage level such as 0V, −3V or −5V on the second pad 234. The voltage waveforms in the driving circuit 200 are shown in FIG. 2B. For example, when the second operational amplifier 220 is operative, the two first switches 212 and 214 are switched off and the two second switches 222 and 224 are switched on, the voltage VCOM_P on the second pad 234 of the driving circuit 200 is overdriven to a low voltage level when compared to that on the pad 130 of the conventional driving circuit 100. In this manner, the common voltage VCOM_G on the common electrode reaches a targeted low voltage level faster than conventional methods. Additionally, at the same time, the common voltage VCOM_G is fed back to the inverting input terminal of the second operational amplifier 220. Thus, improving the low voltage level response of the common voltage VCOM_G.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A common voltage driving circuit configured to output a common voltage to high-resolution TFT-LCD, comprising:
a first pad coupled to a common electrode loading of an LCD for sensing a common voltage of the common electrode loading;
a second pad coupled to the common electrode loading;
a first amplifying device receiving a high level voltage and the sensed common voltage of the common electrode loading for generating a first overdrive voltage to the second pad thereby improving transient response of the common voltage with high level; and
a second amplifying device receiving a low voltage level voltage and the sensed common voltage of the common electrode loading for generating a second overdrive voltage to the second pad thereby improving transient response of the common voltage with low level.

2. The circuit as claimed in claim 1, further comprising:
two first switches for switching the connection between the first amplifying device and the first pad, and the first amplifying device and the second pad respectively; and
two second switches for switching the connection between the second amplifying device and the first pad and the second amplifying device and the second pad respectively.

3. The circuit as claimed in claim 1, wherein the two first switches are switched on and the two second switches are switched off when the first amplifying device is operative, and the two first switches are switched off and the two second switches are switched on when the second amplifying device is operative.

4. The circuit as claimed in claim 1 is implemented inside a driver integrated circuit chip.
